(19) United States
(12) Patent Application Publication
(10) Pub. No.: US 2011/0151405 A1
(43) Pub. Date: Jun. 23, 2011

(54) SUCTION SWAB AND METHOD OF MAKING SAME

(75) Inventor: Alan R. Dombrowski, Woodbury, MN (US)

(73) Assignee: 3M Innovative Properties Company

(21) Appl. No.: 12/961,558

(22) Filed: Dec. 7, 2010

Related U.S. Application Data
(60) Provisional application No. 61/287,450, filed on Dec. 17, 2009.

(51) Int. Cl. A61C 17/08

(52) U.S. Cl. 433/96

(57) ABSTRACT

A suction swab and a method of making a suction swab. The suction swab can include a shaft, a pad coupled to the shaft, and an aperture formed through the pad and the shaft. The shaft can be elongated and can have a lumen, a longitudinal direction and an outer transverse dimension oriented substantially perpendicularly with respect to the longitudinal direction. The shaft can include a proximal end and a distal end. The proximal end can be coupled to a suction source. The aperture can be in fluid communication with the lumen of the shaft, can be elongated, and can have a width and a length greater than the width. The length of the aperture can be greater than the outer transverse dimension of the shaft. The method can include coupling the pad to the distal end of the shaft, and forming an aperture through the pad and the shaft.

### RELATED APPLICATIONS

Priority is hereby claimed to U.S. Provisional Application No. 61/287,450, filed Dec. 17, 2009.

### FIELD

The present disclosure generally relates to suction swabs for oral care, and particularly, to suction swabs having non-circular or elongated apertures.

### BACKGROUND

Patients who are on a ventilator for more than 48 hours can acquire an infection known as Ventilator Associated Pneumonia (VAP). In some cases, the chance of acquiring VAP can be reduced by practicing an effective oral care protocol on ventilated patients. For example, in some cases, oral care can be performed by brushing teeth (e.g., with a suction toothbrush); applying an oral cleanser or antiseptic (e.g., with a suction swab); and/or removing or suctioning oral secretions (e.g., with the suction toothbrush, the suction swab, and/or a Yankauer suction device).

Patients who are ventilated with an endotracheal tube can have a large amount of oral secretions, which, if not removed from the oral cavity, can build up excessively. The process of debridement can be performed on such patients to remove and inhibit the build-up of oral secretions. Such a debriding process can include applying a debriding agent (e.g., with a suction swab) to the oral cavity, which can break down mucus, and suctioning secretions (e.g., with a suction swab).

Suction swabs can also be used to cleanse and/or suction oral secretions during various dental or medical procedures and/or to prepare a patient's mouth for various dental or medical procedures.

### SUMMARY

Some embodiments of the present disclosure provide a suction swab. The suction swab can include a shaft, a pad coupled to the shaft, and an aperture formed through the pad and the shaft. The shaft can be elongated and can have a lumen, a longitudinal direction and an outer transverse dimension oriented substantially perpendicularly with respect to the longitudinal direction. The shaft can include a proximal end and a distal end in fluid communication with the proximal end. The proximal end can be adapted to be coupled to a suction source. The aperture can be in fluid communication with the lumen of the shaft. The aperture can be elongated and can have a width and a length greater than the width. The length of the aperture can be greater than the outer transverse dimension of the shaft.

Some embodiments of the present disclosure provide a method of making a suction swab. The method can include providing a shaft, coupling a pad to a distal end of the shaft, and forming an aperture through the pad and the shaft. The shaft can be elongated and can have a lumen, a longitudinal direction and an outer transverse dimension oriented substantially perpendicularly with respect to the longitudinal direction. The shaft can include a proximal end in fluid communication with the distal end. The proximal end can be adapted to be coupled to a suction source. The aperture can be in fluid communication with the lumen of the shaft. The aperture can be elongated and can have a width and a length greater than the width. The length of the aperture can be greater than the outer transverse dimension of the shaft.

Other features and aspects of the present disclosure will become apparent by consideration of the detailed description and accompanying drawings.

### BRIEF DESCRIPTION OF THE DRAWINGS

FIG. 1 is a perspective view of a suction swab according to one embodiment of the present disclosure.

FIG. 2 is a close-up top plan view of the suction swab of FIG. 1.

FIG. 3 is a close-up side cross-sectional view of the suction swab of FIGS. 1 and 2, taken along line 3-3 of FIG. 2.

FIG. 4 is a close-up end cross-sectional view of the suction swab of FIGS. 1-3, taken along line 4-4 of FIG. 2.

FIG. 5 is a close-up top plan view of a suction swab according to another embodiment of the present disclosure.

### DETAILED DESCRIPTION

Before any embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the term “coupled” and variations thereof is used broadly and encompasses both direct and indirect couplings. Further, “connected” and “coupled” are not restricted to physical or mechanical connections or couplings. It is to be understood that other embodiments may be utilized and structural or logical changes may be made without departing from the scope of the present disclosure. Furthermore, terms such as “front,” “rear,” “top,” “bottom,” and the like are only used to describe elements as they relate to one another, but are in no way meant to recite specific orientations of the apparatus of the present disclosure, to indicate or imply necessary or required orientations of the apparatus of the present disclosure, or to specify how the invention described herein will be used, mounted, displayed, or positioned in use.

The present disclosure generally relates to a suction swab that can be used to perform oral care, for example, on patients who are on a ventilator (e.g., via an endotracheal (ET) tube).

The suction swabs of the present disclosure can be used to apply an oral cleanser or mouthwash to the patient, and/or to de-bride the oral cavity. In addition, the suction swabs of the present disclosure can be used to suction oral secretions from the mouth. In some embodiments, application of a cleanser and suctioning of oral secretions can be performed simultaneously with suction swabs of the present disclosure.

Some existing suction swabs include a disposable compliant foam member that covers a distal end of a shaft, and further include transverse circular apertures formed through the foam member and shaft (e.g., formed by drilling). In other existing suction swabs, the foam member doesn't cover the distal end of the shaft, and the suction is provided through the distal end of the swab shaft alone, with no suction holes formed through the foam member.

The present inventor recognized various drawbacks associated with all of the above swabs. Swabs with transverse circular apertures in the foam member (e.g., one formed in a top side of the foam member and one formed in the bottom side) can be limited in cross-sectional area, for example, by the diameter of the shaft and the need to have adequate material between the hole and the shaft wall for mechanical strength and integrity of the device. At least partially due to the reduced cross-sectional area, the transverse apertures can easily plug or saturate with heavy (e.g., ropy) oral secretions, which can render the device ineffective for suctioning secretions. Furthermore, if one of the transverse circular apertures becomes plugged and a single suction aperture is suctioned against the oral cavity tissue, the tissue can be aspirated into the device, causing trauma to the patient.

Furthermore, in devices in which the foam member does not suitably cover the distal end of the shaft, or in which portions of the device are formed of a hard, non-forgiving material (e.g., a hard plastic), the device can cause pain or trauma to a patient when manipulated in the patient's mouth.

Moreover, another drawback with some existing suction swabs is that some existing methods of making suction swabs can be cumbersome, tedious or complicated, for example, when adhesive is accumulated in suction apertures of the swab during fabrication, which can result in a defective product.

On the contrary, the suction swabs of the present disclosure can be disposable and can include an aperture configured for suctioning that has an increased open area, while maintaining an adequate amount of remaining material between the aperture and an outer dimension of the shaft to provide mechanical support and integrity to the suction swab and to inhibit the pad from breaking off, for example, during use. As a result, in some embodiments, shafts of smaller size and/or lower profile can be used while maintaining a suitable cross-sectional area for suctioning and minimizing the risk of aspirating tissue due to clogging a suction aperture. Furthermore, the placement of the pad over the distal end of the shaft can reduce any pain or discomfort resulting from manipulating the suction swab in a patient's mouth. In addition, the suction swabs of the present disclosure can be manufactured, and apertures can be formed, according to a simple, robust, and efficient process that does not limit the aperture shape, size, or quantity.

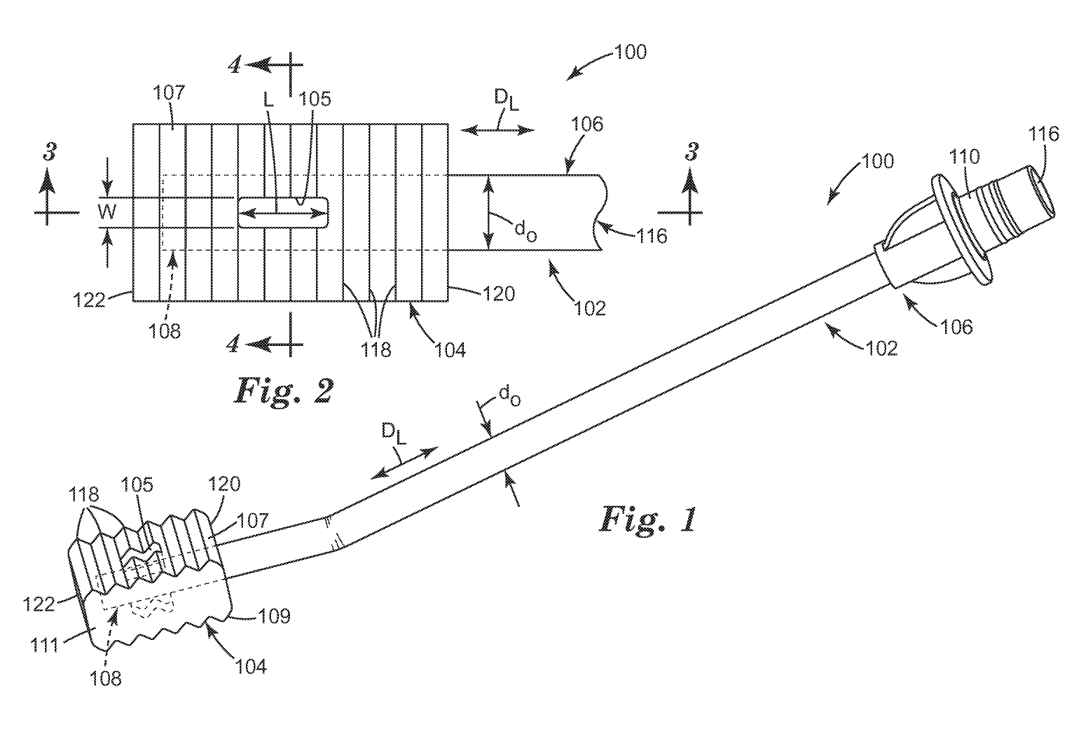

FIGS. 1-4 illustrate a suction swab 100 according to one embodiment of the present disclosure. As shown in FIGS. 1-4, the suction swab 100 can include a relatively rigid shaft 102, a relatively compliant pad 104 coupled to the shaft 102, and an aperture 105 (e.g., a “transverse” aperture) formed through the shaft 102 and the pad 104.

As shown in FIGS. 1-4, the shaft 102 can include a proximal end 106 adapted to be coupled to a suction source (not shown) and a distal end 108 in fluid communication with the proximal end 106. As further shown, the pad 104 can be coupled to the distal end 108 of the shaft 102. The pad 104 can further includes a top side 107 and a bottom side 109. In some embodiments, the aperture 105 can be formed through only one of the top and bottom sides 107 and 109. However, as shown in FIGS. 1-4, in some embodiments, the aperture 105 can be formed through both the top side 107 and the bottom side 109 of the pad 104. As such, in some embodiments, the aperture 105 can be referred to as two apertures 105—a first aperture 105 formed through the top side 107 of the pad 104 and the shaft 102, and a second aperture 105 formed through the bottom side 109 of the pad 104 and the shaft 102. By forming the aperture 105 all the way through the pad 104 and the shaft 102, as shown in FIGS. 1-4, the total open area available for suctioning can be doubled.

The proximal end 106 of the shaft 102 can include a connector 110 adapted to couple the suction swab 100 to a suction source. The connector 110 can include any suitable couplings or connectors for coupling the suction swab 100 to a suction source (or an intermediate device, such as a suction handle), and the connector 110 is shown by way of example only.

The shaft 102 can be formed of suitable polymers that provide the desired strength and rigidity during use but are also not so brittle that formation of the aperture 105 through the shaft 102 is inhibited or impossible. Examples of polymers that can be used can include, but are not limited to, polyethylene, polypropylene, high-impact polystyrene (HIPS), or combinations thereof. Particular advantages were observed when the shaft 102 was formed of polypropylene, at least partially due to its high strength and elongation, such that the aperture 105 could be formed through the shaft 102 by a punching process, a stamping process, or the like, or combinations thereof, without resulting in a distal end 108 of the shaft 102 that can brittle fracture.

In some embodiments, the shaft 102 can be formed of a high flexural modulus material. For example, in some embodiments, the shaft 102 can be formed of a material having a flexural modulus of at least about 150,000 psi (about 1 GPa), in some embodiments, at least about 170,000 psi (about 1.2 GPa), and in some embodiments, at least about 200,000 psi (about 1.4 GPa).

In some embodiments, the shaft 102 can be formed of a material having a tensile elongation of at least about 10%. Furthermore, in some embodiments, the shaft 102 can be formed of a material having a tensile yield strength of at least about 4000 psi (about 28 MPa), in some embodiments, at least about 4500 psi (about 31 MPa), and in some embodiments, at least about 5000 psi (about 34 MPa).

The shaft 102 can be formed by a variety of processes, depending at least partially on the material makeup of the shaft 102. For example, in some embodiments, the shaft 102 can be molded, such as injection molded, extruded, or the like, or combinations thereof.

Furthermore, the shaft 102 is shown in FIG. 1 as having a bent profile, which can enhance access to remote portions of an oral cavity. However, the profile shown in FIG. 1 is shown by way of example only, and it should be understood that other profiles, including other bent profiles, can be employed without departing from the scope of the present disclosure.

As shown in FIG. 1, the shaft 102 (and the suction swab 100, in general) can be elongated and can have a longitudinal direction D_{L}. The shaft 102 can include an outer transverse dimension dₒ oriented substantially perpendicularly with respect to the longitudinal direction D_{L}. In embodiments in which the cross-sectional shape of the shaft 102 is substantially circular, as shown, the outer transverse dimension dₒ can be an outer diameter.

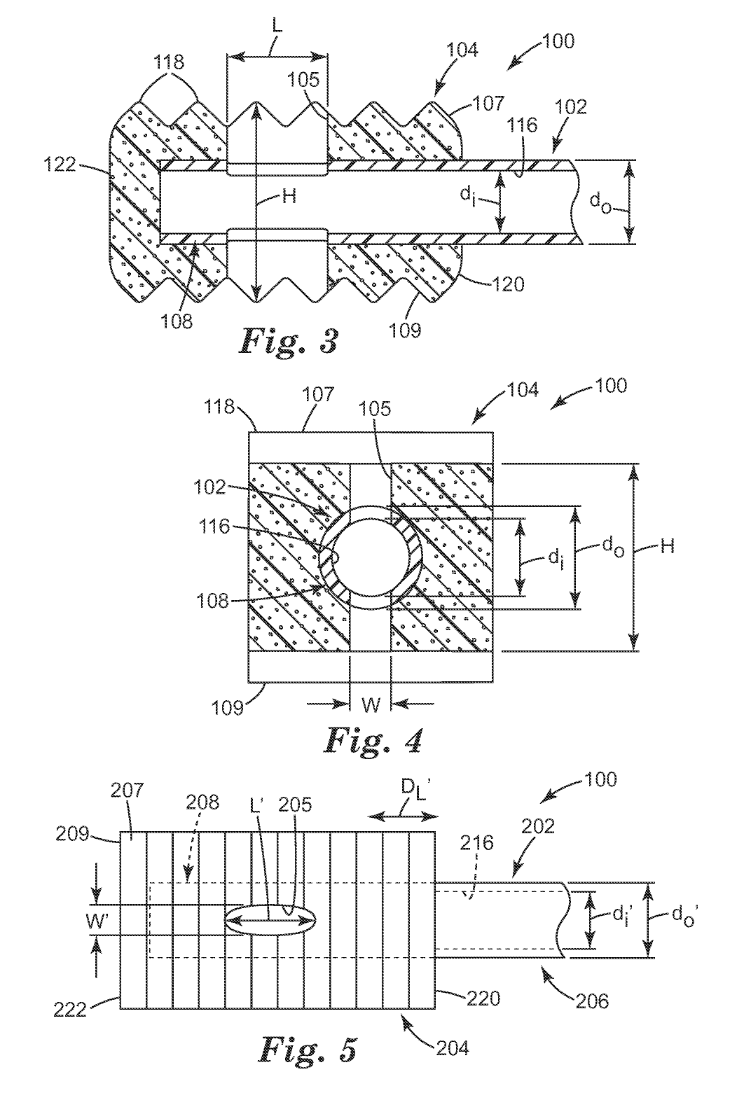

In addition, the shaft 102 can include an inner transverse dimension dᵢ (see, e.g., FIGS. 3 and 4), which can also be oriented substantially perpendicularly with respect to the longitudinal direction D_{L} of the shaft 102. The inner transverse dimension dᵢ can at least partially define a lumen 116 of the shaft 102. In embodiments in which the cross-sectional shape of the shaft 102 is substantially circular, as shown, the inner transverse dimension dᵢ can be an inner diameter. The aperture 105 can be positioned to fluidly couple ambience and the lumen 116 of the shaft 102 (and, accordingly, to fluidly couple ambience and a suction source).

In some embodiments, the outer transverse dimension dₒ can be at least about 0.15 inches (0.4 cm), and in some embodiments, at least about 0.2 inches (0.5 cm). In some embodiments, the outer transverse dimension dₒ can be no greater than about 0.35 inches (0.9 cm), and in some embodiments, no greater than about 0.25 inches (0.6 cm).

In some embodiments, the inner transverse dimension dᵢ can be at least about 0.1 inches (0.3 cm), and in some embodiments, at least about 0.15 inches (0.4 cm). In some embodiments, the inner transverse dimension dᵢ can be no greater than about 0.34 inches (0.9 cm), in some embodiments, no greater than about 0.3 inches (0.8 cm), and in some embodiments, no greater than about 0.2 inches (0.5 cm). In some embodiments, the inner transverse dimension dᵢ is about 0.215 inches (0.55 cm). In some embodiments, the inner transverse dimension dᵢ is about 0.18 inches (0.46 cm).

In some embodiments, the wall thickness of the shaft 102 can be at least about 0.01 inches (0.03 cm), in some embodiments, at least about 0.02 inches (0.05 cm), in some embodiments, at least about 0.03 inches (0.08 cm), in some embodiments, at least about 0.035 inches (0.09 cm), and in some embodiments, at least about 0.04 inches (0.10 cm). In some embodiments, the wall thickness of the shaft 102 can be no greater than about 0.1 inches (0.3 cm), in some embodiments, no greater than about 0.08 inches (0.20 cm), in some embodiments, no greater than about 0.06 inches (0.15 cm), in some embodiments, no greater than about 0.05 inches (0.13 cm), in some embodiments, no greater than about 0.045 inches (0.114 cm). In some embodiments, the wall thickness of the shaft 102 ranges from about 0.03 inches (0.08 cm) to about 0.04 inches (0.10 cm).

As shown in FIGS. 1-4, the pad 104 can include a proximal end 120 and a distal end 122. As further shown, the pad 104 can be coupled to the distal end 108 of the shaft 102. In some embodiments, the pad 104 can be coupled to the shaft 102 such that the pad 104 covers at least a portion of the shaft 102, and such that the distal end 122 of the pad 104 extends further distally than the distal end 108 (e.g., the outermost end) of the shaft 102.

The pad 104 can be formed of a variety of materials, including, but not limited to, a soft cushioning and compliant material (e.g. to protect soft tissues of the oral cavity), such as a polyurethane-based foam, a polyether-based foam, a polyester-based foam, other suitable materials, or combinations thereof.

The pad 104 can be formed by a variety of processes, depending at least partially on the material makeup of the pad 104. For example, in some embodiments, the pad 104 can be formed by foaming, such as injecting external gases or creating those gases with the components of the foams when they are reacting, or the like, or combinations thereof.

Furthermore, the pad 104 can include one or more ridges and/or valleys 118 (see, e.g., FIG. 3), which can enhance effective cleaning of an oral cavity. However, the profile shown in FIG. 1-4 is shown by way of example only, and it should be understood that other profiles, including other shapes or pad profiles, can be employed without departing from the scope of the present disclosure. In addition, it should be understood that the pad 104 can have any shape or size suitable for a desired application, and the relative size between the pad 104 and the shaft 102 is shown by way of example only.

As mentioned above, the aperture 105 can be formed through the pad 104 and the shaft 102, such that the aperture 105 is provided in fluid communication with the lumen 116 of the shaft 102. As shown in FIGS. 1-4, the aperture 105 can be elongated and can have a width W and a length L greater than the width W. In some embodiments, as shown in FIGS. 2 and 4, the width W of the aperture 105 can be less than the inner transverse dimension dᵢ of the shaft 102 (and, accordingly, less than the outer transverse dimension dₒ of the shaft 102).

In some embodiments, if the width W of the aperture 105 is too wide (e.g., similar in size to the inner transverse dimension dᵢ of the shaft 102), there can be a risk of cracking the shaft 102 or of the shaft 102 have a weaker distal end 108. In some embodiments, and without limiting the present disclosure, these problems may be solved by controlling the ratio of the width W of the aperture 105 to the inner transverse dimension dᵢ of the shaft 102, which can allow for alignment tolerance during the manufacturing process for an acceptably functioning shaft 102.

In some embodiments, the ratio of the width W of the aperture 105 to the inner transverse dimension dᵢ of the shaft 102 can be at least about 0.1, in some embodiments at least about 0.25, and in some embodiments, at least about 0.5. In some embodiments, the ratio of the width W of the aperture 105 to the inner transverse dimension dᵢ of the shaft 102 can be no greater than about 0.8, in some embodiments, no greater than about 0.75, and in some embodiments, no greater than about 0.6.

In some embodiments, the width W of the aperture 105 can be at least about 0.05 inches (0.10 cm), in some embodiments, at least about 0.06 inches (0.15 cm), in some embodiments, at least about 0.07 inches (0.18 cm), and in some embodiments, at least about 0.1 (0.3 cm). In some embodiments, the width W of the aperture 105 can be no greater than about 0.3 inches (0.8 cm), in some embodiments, no greater than about 0.275 inches (0.7 cm), in some embodiments, no greater than about 0.25 inches (0.6 cm), and in some embodiments, no greater than about 0.2 inches (0.5 cm). In some embodiments, the width W of the aperture 105 is about 0.135 inches (0.35 cm).

In some embodiments, ratio of the length L of the aperture 105 to the width W of the aperture 105 can be greater than 1, in some embodiments, at least about 1.5, in some embodiments, at least about 2, in some embodiments, at least about 3, and in some embodiments, at least about 4. In some embodiments, the ratio of the length L of the aperture 105 to the width W of the aperture 105 can be no greater than about 8, in some embodiments, no greater than about 6, and in some embodiments, no greater than about 5.

In addition, in some embodiments, the length L of the aperture 105 can be greater than or equal to the outer transverse dimension dₒ of the shaft 102. Furthermore, in some embodiments, the length L of the aperture 105 can be greater than the inner transverse dimension dᵢ of the shaft 102.

As mentioned above, in some embodiments, the length L of the aperture 105 can be greater than the outer transverse dimension dₒ of the shaft 102. In some embodiments, the ratio of the length L of the aperture 105 to the outer transverse dimension dₒ of the shaft 102 can be at least about 1, in some embodiments, at least about 1.2, and in some embodiments, at least about 1.5. In some embodiments, the ratio of the length L of the aperture 105 to the outer transverse dimension dₒ of the shaft 102 can be no greater than about 5, in some embodiments, no greater than about 4, and in some embodiments, no greater than about 3.

In some embodiments, the length L of the aperture 105 can be at least about 0.175 inches (0.45 cm), in some embodiments, at least about 0.2 inches (0.5 cm), in some embodiments, at least about 0.25 inches (0.6 cm), and in some embodiments, at least about 0.3 inches (0.8 cm). In some embodiments, the length L of the aperture 105 can be no greater than about 2.5 inches (6.4 cm), in some embodiments, no greater than about 1.5 inches (3.8 cm), in some embodiments, no greater than about 1.0 inch (2.5 cm), and in some embodiments, no greater than about 0.8 inches (2 cm).

In some embodiments, the open area or cross-sectional area (e.g., width W×length L, for example, when the aperture 105 is sectioned along a plane parallel to the top side 107 of the pad 104) of the aperture 105 can be at least about 0.015 square inches (in²; 0.1 cm²), in some embodiments, at least about 0.02 in² (0.15 cm²), in some embodiments, at least about 0.03 in² (0.2 cm²), and in some embodiments, at least about 0.05 in² (0.3 cm²). In some embodiments, the open area of the aperture 105 can be no greater than about 0.2 in² (1.5 cm²), in some embodiments, no greater than about 0.15 in² (1 cm²), and in some embodiments, no greater than about 0.1 in² (0.6 cm²).

In some embodiments, the length L of the aperture 105 is greater than or equal to the outer transverse dimension dₒ of the shaft 102; the ratio of the length L of the aperture 105 to the width W of the aperture 105 is greater than 1.0 and no greater than 8.0; and the ratio of the width W of the aperture 105 to the inner transverse dimension dᵢ is no greater than 0.8.

The aperture 105 can also include a height H, which can be at least partially determined by the height of the pad 104.

The aperture 105 is shown in FIGS. 1-4 as having a generally rectangular cross-sectional shape; however, other aperture shapes are possible, such as the aperture shown in FIG. 5 and described below, without departing from the scope of the present disclosure.

As shown, the aperture 105 has a generally elongated shape, which in some embodiments, can increase the surface area or open area available for suctioning, while still providing an adequate amount of remaining material between the punched aperture 105 (e.g., the width W of the aperture 105) and the shaft outer transverse dimension dₒ to provide mechanical support for the shaft 102. As discussed above, such a relationship of aperture size and shaft size can inhibit the shaft 102 from breaking or from the distal end 108 of the shaft 102 from snapping off during use.

In some embodiments, the increased open area resulting from an elongated aperture 105 can reduce that likelihood of the aperture 105 from becoming clogged or obstructed during suctioning. As a result, a smaller shaft 102 can be employed (e.g., a shaft 102 having a smaller outer transverse dimension dₒ).

In the embodiment illustrated in FIGS. 1-4, the suction swab 100 is shown as including one aperture 105 for suctioning (or two, as described above). However, it should be understood that as few as one aperture 105 and as many apertures 105 as necessary or structurally possible can be employed without departing from the scope of the present disclosure. In some embodiments, multiple apertures 105 can allow the suction swab 100 to continue aspirating even after one aperture 105 has become plugged or clogged. In addition, multiple apertures 105 can inhibit the suction swab 100 from adhering to oral mucosa if one of the apertures 105 becomes plugged. In some embodiments employing a plurality of apertures 105, at least two of the plurality of apertures 105 can be positioned at an angle of 90 degrees with respect to one another.

In some embodiments, additional suction apertures 105 can be formed in one or more sidewalls 111 of the pad 104. For example, in some embodiments, the suction swab 100 can include a first aperture 105 formed through the top side 107 of the pad 104 and the shaft 102, a second aperture 105 formed through the bottom side 109 of the pad 104 and the shaft 102 (or these together can be referred to as one aperture 105), a third aperture 105 formed through a sidewall 111 of the pad 104 and the shaft 102, and a further aperture 105 formed through an opposite sidewall 111 of the pad 104 and the shaft 102 (or these together can be referred to as one aperture 105). For example, the first and second apertures 105 through the top and bottom sides 107 and 109 can be vertical transverse apertures 105, and the third and fourth apertures 105 through the sidewalls 111 can be horizontal transverse apertures 105, such that the first set of vertical apertures 105 are oriented substantially perpendicularly with respect to the second set of horizontal apertures 105.

In some embodiments, the suction swab 100 can include one vertical aperture 105 (e.g., formed through the top side 107 or the bottom side 109 of the pad 104) and one horizontal aperture 105 (e.g., formed through one sidewall 111 of the pad 104), such that the suction swab 100 includes two blunt-end apertures 105 oriented substantially perpendicularly with respect to one another.

Furthermore, in some embodiments, the pad 104 can be round or cylindrical, such that the pad 104 does not necessarily include a top side 107, bottom side 109 and sidewall 111, as depicted in FIG. 1, but rather includes an arcuate or round outer surface. In such embodiments, a plurality of apertures 105 can be formed around the circumference or outer surface of the pad 104 (e.g., that either stop at the lumen 116 of the shaft 102 or that continue through the shaft 102 to the opposite side of the pad 104).

In embodiments in which the aperture 105 extends through the top side 107 and the bottom side 109, as shown in FIGS. 1-4, or in which the suction swab 100 includes a variety of apertures 105, the total open area or total cross-sectional area available for suction on the suction swab 100 (e.g., the sum of the individual open areas of the apertures 105) can be at least about 0.035 in² (0.2 cm²), in some embodiments, at least about at least about 0.05 in² (0.3 cm²), and in some embodiments, at least about 0.1 in² (0.5 cm²). In some embodiments, the total open area can be no greater than about 0.4 in² (2.5 cm²), in some embodiments, no greater than about 0.3 in² (2 cm²), and in some embodiments, no greater than about 0.2 in² (1.5 cm²).

The suction swab 100 described herein can be made by providing a shaft 102 and coupling the pad 104 to the distal end 108 of the shaft 102, for example, using adhesive to bond the pad 104 to the outer surface of the shaft. In some embodiments, the pad 104 can include a recess or aperture dimensioned to receive at least a portion of the shaft 102 (and a corresponding inner surface) to facilitate coupling the pad 104 to the distal end 108 of the shaft 102.

In some embodiments, a punch (e.g., a metal punch in a fixture) can be used to form an aperture 105 through the pad 104 and the shaft 102, to form the aperture 105 by simultaneously punching the shaft 102 and the pad 104, such that the aperture 105 is in fluid communication with the lumen 116 of the shaft 102. In some embodiments, one or both of the pad 104 and the shaft 102 can be held in place to inhibit the pad 104 and/or the shaft 102 from rotating or turning while the aperture 105 is formed. In addition, in some embodiments, the punching process can include a substantially vertical motion only, or motion only along one axis, such that the punching process does not include horizontal motion, for example. In some embodiments, more than one aperture 105 can be formed through the pad 104 and the shaft 102, and in such embodiments, the plurality of apertures 105 can be formed sequentially or simultaneously.

At least partially because the aperture 105 can be formed through both the shaft 102 and the pad 104 after the pad 104 has been coupled to the shaft 102, manufacturing of the suction swab 100 can be facilitated. For example, in some existing systems employing a distal end suction hole, special care may need to be taken to ensure that the distal end of a shaft does not fill with adhesive when a pad is coupled to the shaft. On the contrary, in manufacturing the suction swab 100 of FIGS. 1-4, adhesive can be positioned either on an outer surface of the shaft 102 or an inner surface of the pad 104, and the distal end 108 of the shaft 102 can be positioned in the pad 104, without concern for whether the distal end 108 of the shaft 102 fills with adhesive in the process, at least partially because the aperture 105 will later be punched through the shaft 102 and the pad 104, removing any such obstruction.

FIG. 5 illustrates a suction swab 200 according to another embodiment of the present disclosure, wherein like numerals represent like elements. The suction swab 200 shares many of the same elements and features described above with reference to the illustrated embodiment of FIGS. 1-4. Accordingly, elements and features corresponding to elements and features in the illustrated embodiment of FIGS. 1-4 are provided with the same reference numerals in the 200 series. Reference is made to the description above accompanying FIGS. 1-4 for a more complete description of the features and elements (and alternatives to such features and elements) of the embodiment illustrated in FIG. 5.

As shown in FIG. 5, the suction swab 200 can include a shaft 202, a pad 204 coupled to the shaft 202, and an aperture 205 formed through the shaft 202 and the pad 204. The pad 204 can further includes a top side 207 and a bottom side 209. As shown in FIG. 5, in some embodiments, the aperture 205 can be formed through both the top side 207 and the bottom side 209 of the pad 204. However, in some embodiments, the aperture 205 can be formed through only one of the top and bottom sides 207 and 209.

The shaft 202 can include a proximal end 206 adapted to be coupled to a suction source (not shown) and a distal end 208 in fluid communication with the proximal end 206. As further shown, the pad 204 can be coupled to the distal end 208 of the shaft 202. The proximal end 206 of the shaft 202 can include or be coupled to a connector (such as the connector 110 shown in FIGS. 1-4), which is not shown in FIG. 5 for clarity.

As shown in FIG. 5, the shaft 202 can be elongated and can have a longitudinal direction D_{L}′ and an outer transverse dimension dₒ′ oriented substantially perpendicularly with respect to the longitudinal direction D_{L}′. In embodiments in which the cross-sectional shape of the shaft 202 is substantially circular, as shown, the outer transverse dimension dₒ′ can be an outer diameter.

In addition, the shaft 202 can include an inner transverse dimension dᵢ′ (see, e.g., FIG. 5), which can also be oriented substantially perpendicularly with respect to the longitudinal direction D_{L}′ of the shaft 202. The inner transverse dimension dᵢ′ can at least partially define a lumen 216 of the shaft 202. In embodiments in which the cross-sectional shape of the shaft 202 is substantially circular, as shown, the inner transverse dimension dᵢ′ can be an inner diameter.

As shown in FIG. 5, the pad 204 can include a proximal end 220 and a distal end 222. As further shown, the pad 204 can be coupled to the distal end 208 of the shaft 202, such that the distal end 222 of the pad 204 extends further distally than the distal end 208 of the shaft 202. Similar to the pad 104, the pad 204 can include ridges or valleys 218.

Unlike the aperture 105 of the embodiment shown in FIGS. 1-4 and described above, the aperture 205 of FIG. 5 has a generally elliptical or oval shape. As shown in FIG. 5, the aperture 205 can include a width W′ and a length L′ greater than the width W′. In some embodiments, as shown in FIG. 5, the width and/or the length can vary. In such embodiments, W′ and L′ can refer to the maximal width and length, respectively, of the aperture 205. In some embodiments, as shown in FIG. 5, the width W′ of the aperture 205 can be less than the inner transverse dimension dᵢ′ of the shaft 202 (and, accordingly, less than the outer transverse dimension dₒ′ of the shaft 202).

In addition, in some embodiments, the length L′ of the aperture 205 can be greater than or equal to the outer transverse dimension dₒ′ of the shaft 202. Furthermore, in some embodiments, the length L′ of the aperture 205 can be greater than the inner transverse dimension dᵢ′ of the shaft 202, and can also be greater than the outer transverse dimension dₒ′ of the shaft 202.

The aperture 205 is shown in FIG. 5 as having a generally elliptical or oval shape; however, other aperture shapes are possible without departing from the scope of the present disclosure.

### EMBODIMENTS

Embodiment 1 is a suction swab comprising:
a shaft, the shaft being elongated and having a lumen, a longitudinal direction and an outer transverse dimension oriented substantially perpendicularly with respect to the longitudinal direction, the shaft including a proximal end and a distal end in fluid communication with the proximal end, the proximal end adapted to be coupled to a suction source;
a pad coupled to the distal end of the shaft; and
an aperture formed through the pad and the shaft, the aperture being in fluid communication with the lumen of the shaft, the aperture being elongated and having a width and a length greater than the width, the length being greater than the outer transverse dimension of the shaft.

Embodiment 2 is the suction swab of embodiment 1, wherein the shaft is formed of polypropylene.

Embodiment 3 is the suction swab of embodiment 1 or 2, wherein the shaft further includes an inner transverse dimension oriented substantially perpendicularly with respect to the longitudinal direction of the shaft.

Embodiment 4 is the suction swab of embodiment 3, wherein the inner transverse dimension is at least about 0.3 cm.

Embodiment 5 is the suction swab of embodiment 3 or 4, wherein the width of the aperture is less than the inner transverse dimension of the shaft.

Embodiment 6 is the suction swab of any of embodiments 3-5, wherein the ratio of the width of the aperture to the inner transverse dimension of the shaft is no greater than about 0.8.

Embodiment 7 is the suction swab of any of embodiments 1-6, wherein the outer transverse dimension is no greater than about 0.9 cm.

Embodiment 8 is the suction swab of any of embodiments 1-7, wherein the aperture includes a cross-sectional area of at least about 0.15 cm².

Embodiment 9 is the suction swab of any of embodiments 1-8, wherein the suction swab includes a total open area for suctioning of at least about 0.3 cm².

Embodiment 10 is the suction swab of any of embodiments 1-9, wherein the aperture is one of a plurality of apertures, and wherein at least two of the plurality of apertures are oriented substantially perpendicularly with respect to one another.

Embodiment 11 is the suction swab of any of embodiments 1-10, wherein the ratio of the length of the aperture to the width of the aperture is at least about 2.

Embodiment 12 is the suction swab of any of embodiments 1-11, wherein the ratio of the length of the aperture to the width of the aperture is no greater than about 8.

Embodiment 13 is the suction swab of any of embodiments 1-12, wherein the ratio of the length of the aperture to the outer transverse dimension of the shaft is at least about 1.2.

Embodiment 14 is the suction swab of any of embodiments 1-13, wherein the pad includes a proximal end and a distal end, and wherein the pad is coupled to the distal end of the shaft, such that the distal end of the pad extends further distally than the distal end of the shaft.

Embodiment 15 is the suction swab of any of embodiments 1-14, wherein the width of the aperture is no greater than about 0.5 cm.

Embodiment 16 is the suction swab of any of embodiments 1-15, wherein the length of the aperture is at least about 0.5 cm.

Embodiment 17 is the suction swab of any of embodiments 1-16, wherein the pad includes at least one ridge.

The following prophetic examples are intended to be illustrative of the present disclosure and not limiting.

### Examples

Prophetic Examples 1-9 represent nine exemplary suction swabs according to the present disclosure and configured as shown in FIGS. 1-4, each having a rectangular aperture. Comparative Example A is an existing Sage suction swab (e.g., the suction swab found in the 24 hour kit-product no. 6804, available from Sage Products, Inc., Crystal Lake, Ill.). Comparative Example A is described and illustrated in U.S. Pat. Nos. 5,151,094 and 5,085,633, and includes a circular aperture, having a radius and a diameter. Comparative Example B is prophetic comparative example suction swab having a circular aperture (formed like Comparative A) with a diameter equal to that of the shaft inner diameter, and a shaft outer diameter of 0.250 inches (0.635 cm).

Prophetic Examples 1-9 include possible dimensions of various features of suction swabs of the present disclosure. Table 1 shows the comparison of these dimensions with the Comparative Examples A and B. Particularly, Table 1 shows a comparison between the total open area available for suction for prophetic suction swabs of the present disclosure, as compared with Comparative Examples A and B. Measurements of Comparative Example A were taken with a calipers. In Table 1, all dimensions and areas are shown in inches and square inches, respectively. In addition, all dimensions and areas are shown in centimeters and square centimeters, respectively, underneath the value in inches or square inches.

TABLE 1
Suction Swab Dimensions and Total Open Area comparison

| | | | | | Aperture | | | | | Total |
|---|---|---|---|---|---|---|---|---|---|---|
| | Shaft | Shaft | Shaft | | Length | | | | Total | Area vs. |
| | Outer | Wall | Inner | Aperture | “L” | | | Aperture | Open | Comp. |
| | Diam. | Thick- | Diam. | Width | Diameter | | | Area | Area | Ex. A |
| Ex | (OD) | ness | (ID) | “W” | for A & B | L/W | W/ID | (A) | (A × 2) | (%) |
| 1 | 0.250 | 0.035 | 0.180 | 0.100 | 0.300 | 3.000 | 0.556 | 0.030 | 0.060 | 170 |
| | 0.635 | 0.089 | 0.458 | 0.254 | 0762 | | | 0.194 | 0.387 | |
| 2 | 0.250 | 0.035 | 0.180 | 0.100 | 0.250 | 2.500 | 0.556 | 0.025 | 0.050 | 142 |
| | 0.635 | 0.089 | 0.458 | 0.254 | 0.635 | | | 0.161 | 0.323 | |
| 3 | 0.250 | 0.035 | 0.180 | 0.135 | 1.080 | 8.000 | 0.750 | 0.146 | 0.292 | 825 |
| | 0.635 | 0.089 | 0.458 | 0.343 | 2.743 | | | 0.942 | 1.88 | |
| 4 | 0.250 | 0.035 | 0.180 | 0.100 | 0.800 | 8.000 | 0.556 | 0.080 | 0.160 | 453 |
| | 0.635 | 0.089 | 0.458 | 0.254 | 2.03 | | | 0.516 | 1.03 | |
| 5 | 0.250 | 0.035 | 0.180 | 0.144 | 0.250 | 1.736 | 0.800 | 0.036 | 0.072 | 204 |
| | 0.635 | 0.089 | 0.458 | 0.366 | 0.635 | | | 0.232 | 0.465 | |
| 6 | 0.250 | 0.035 | 0.180 | 0.050 | 0.400 | 8.000 | 0.278 | 0.020 | 0.040 | 113 |
| | 0.635 | 0.089 | 0.458 | 0.127 | 1.01 | | | 0.129 | 0.258 | |
| 7 | 0.250 | 0.035 | 0.180 | 0.071 | 0.250 | 3.521 | 0.394 | 0.018 | 0.036 | 100 |
| | 0.635 | 0.089 | 0.458 | 0.180 | 0.635 | | | 0.116 | 0.232 | |
| 8 | 0.150 | 0.020 | 0.110 | 0.060 | 0.300 | 5.000 | 0.545 | 0.018 | 0.036 | 102 |
| | 0.381 | 0.051 | 0.279 | 0.152 | 0762 | | | 0.116 | 0.232 | |
| 9 | 0.350 | 0.060 | 0.230 | 0.150 | 0.350 | 2.333 | 0.652 | 0.056 | 0.105 | 297 |
| | 0.889 | 0.152 | 0.584 | 0.381 | 0.889 | | | 0.361 | 0.677 | |
| A | 0.230 | 0.027 | 0.176 | N/A | 0.150 | N/A | 0.852 | 0.0177 | 0.035 | 100 |
| | 0.584 | 0.069 | 0.447 | | 0.381 | | | 0.116 | 0.226 | |
| B | 0.250 | 0.035 | 0.180 | N/A | 0.180 | N/A | 1.000 | 0.025 | 0.051 | 146 |
| | 0.635 | 0.089 | 0.458 | | 0.458 | | | 0.161 | 0.329 | |

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure. Various features and aspects of the present disclosure are set forth in the following claims.

What is claimed is:

1. A suction swab comprising:
a shaft, the shaft being elongated and having a lumen, a longitudinal direction and an outer transverse dimension oriented substantially perpendicularly with respect to the longitudinal direction, the shaft including a proximal end and a distal end in fluid communication with the proximal end, the proximal end adapted to be coupled to a suction source;
a pad coupled to the distal end of the shaft; and
an aperture formed through the pad and the shaft, the aperture being in fluid communication with the lumen of the shaft, the aperture being elongated and having a width and a length greater than the width, the length being greater than the outer transverse dimension of the shaft.

2. The suction swab of claim 1, wherein the shaft is formed of polypropylene.

3. The suction swab of claim 1, wherein the shaft further includes an inner transverse dimension oriented substantially perpendicularly with respect to the longitudinal direction of the shaft.

4. The suction swab of claim 3, wherein the inner transverse dimension is at least about 0.3 cm.

5. The suction swab of claim 3, wherein the width of the aperture is less than the inner transverse dimension of the shaft.

6. The suction swab of claim 3, wherein the ratio of the width of the aperture to the inner transverse dimension of the shaft is no greater than about 0.8.

7. The suction swab of claim 1, wherein the outer transverse dimension is no greater than about 0.9 cm.

8. The suction swab of claim 1, wherein the aperture includes a cross-sectional area of at least about 0.15 cm².

9. The suction swab of claim 1, wherein the suction swab includes a total open area for suctioning of at least about 0.3 cm².

10. The suction swab of claim 1, wherein the aperture is one of a plurality of apertures, and wherein at least two of the plurality of apertures are oriented substantially perpendicularly with respect to one another.

11. The suction swab of claim 1, wherein the ratio of the length of the aperture to the width of the aperture is at least about 2.

12. The suction swab of claim 1, wherein the ratio of the length of the aperture to the width of the aperture is no greater than about 8.

13. The suction swab of claim 1, wherein the ratio of the length of the aperture to the outer transverse dimension of the shaft is at least about 1.2.

14. The suction swab of claim 1, wherein the pad includes a proximal end and a distal end, and wherein the pad is coupled to the distal end of the shaft, such that the distal end of the pad extends further distally than the distal end of the shaft.

15. The suction swab of claim 1, wherein the width of the aperture is no greater than about 0.5 cm.

16. The suction swab of claim 1, wherein the length of the aperture is at least about 0.5 cm.

17. The suction swab of claim 1, wherein the pad includes at least one ridge.
